(19) United States
(12) Patent Application Publication
(10) Pub. No.: US 2026/0308022 A1
(43) Pub. Date: Oct. 8, 2026

(54) APPARATUS AND METHOD FOR WASTE-WATER REDUCTION IN LABORATORY WATER PURIFICATION SYSTEM

(71) Applicant: THERMO ORION INC., Chelmsford, MA (US)

(72) Inventors: Janam PANDYA, Chelmsford, MA (US); Kannan SRINIVASAN, Chelmsford, MA (US)

(21) Appl. No.: 19/483,298

(22) PCT Filed: May 8, 2024
(86) PCT No.: PCT/US2024/028282

§ 371 Date: Nov. 11, 2025

Related U.S. Application Data
(60) Provisional application No. 63/501,423, filed on May 11, 2023.

(51) Int. Cl. C02F 1/44; B01D 61/02; B01D 61/12; C02F 1/00; C02F 1/42; C02F 103/04

(52) U.S. Cl. CPC C02F 1/441; B01D 61/025; B01D 61/12; C02F 1/008; C02F 1/42; B01D 2311/06; B01D 2313/18; B01D 2313/19; C02F 2103/04; C02F 2201/005; C02F 2209/40; C02F 2301/046

(57) ABSTRACT

A water purification system, comprising: a water feed path configured to receive an input water; a reverse osmosis module configured to (1) receive input from the water feed path and (2) output a permeate and a concentrate; and a recycle loop, the recycle loop being in fluid communication with the reverse osmosis module and the recycle loop being configured to receive the concentrate of the reverse osmosis module, the recycle loop being in fluid communication with an output and being configured to communicate a first portion of the concentrate to the output, and the recycle loop being convertible between (1) a recirculation state in which a second portion of the concentrate is communicated to the water feed path and (2) a standard state in which the second portion of the concentrate is communicated to the output.

### CROSS-REFERENCE TO RELATED APPLICATIONS

The present application claims priority to and the benefit of U.S. patent application No. 63/501,423, “Apparatus And Method For Waste-Water Reduction In Laboratory Water Purification System” (filed May 11, 2023). All foregoing applications are incorporated herein by reference in their entireties for any and all purposes.

### TECHNICAL FIELD

The present disclosure relates to water purification systems.

### BACKGROUND

Ultrapure water (18.2 MΩ·cm resistivity) is a required solvent in a life science laboratory operating at a small or large scale. A typical tap-to-pure water purification unit purifies water through a two-step purification process: reverse osmosis using a reverse osmosis (RO) module and ion exchange deionization (DI) through a packed bed of ion exchange compounds. The RO membrane typically rejects approximately 98% of the ionic load in the incoming water through the reverse osmotic pressure generated by a pump located upstream of the RO module. In the RO module, however, approximately 80% of the incoming water is also rejected as a concentrate stream to waste along with the rejected salts. The remaining approximately 20% of the influent water is purified water and is dispensed as a permeate stream. The waste generated by reverse osmosis technology negatively impacts the sustainability perception and adds operational expenses for the entity.

Typically, multi-stage reverse osmosis technology is utilized to reduce the waste from the RO module, wherein multiple RO modules are placed in a series of concentrate streams to further purify the incoming feed. Such systems, however, are efficient for large-scale desalination plants and are typically considered unreasonable for a laboratory water purification system due to the small and infrequent operation as well as the added cost and maintenance of adding additional components.

Existing approaches in laboratory water purification modules employ several solutions to mitigate water conservation. Some use a deionization module in the recycle loop to produce purified water to merge with the tap water stream as a feed to the RO. Such a system, however, can consume the deionization cartridge rapidly, inducing frequent consumable replacement for customers, thereby increasing the maintenance cost. Another approach uses a motorized flow regulation valve to ensure a constant flow in the recycle loop. Existing approaches, however, have not established an automated means of decision making to selectively choose a water conservation mode to optimize the performance of the water purification system. Accordingly, there is a long-felt need in the art for a system and method of choosing water conservation modes in an automated fashion.

### SUMMARY

In meeting the described long-felt needs, the present disclosure provides a water purification system, comprising: a water feed path configured to receive an input water; a reverse osmosis module configured to (1) receive input from the water feed path and (2) output a permeate and a concentrate; and a recycle loop, the recycle loop being in fluid communication with the reverse osmosis module and the recycle loop being configured to receive the concentrate of the reverse osmosis module, the recycle loop being in fluid communication with an output and being configured to communicate a first portion of the concentrate to the output, and the recycle loop being convertible between (1) a recirculation state in which a second portion of the concentrate is communicated to the water feed path and (2) a standard state in which the second portion of the concentrate is communicated to the output.

Also provided is a water purification system, comprising: a reverse osmosis module configured to (1) receive an input and (2) output a permeate and a concentrate; a deionization module configured to receive the permeate of the reverse osmosis module; and a recycle loop in fluid communication with the reverse osmosis module, the recycle loop being configured to vary an amount of the concentrate of the reverse osmosis module that is communicated to the input.

Further provided is a method, comprising operating a water purification module according to the present disclosure, for example according to any one of Aspects 1-17.

Also provided is a method, comprising: with (a) a reverse osmosis module configured to (1) receive an input and (2) output a permeate and a concentrate and (b) a deionization module configured to receive the permeate of the reverse osmosis module, varying an amount of the concentrate of the reverse osmosis module that is communicated to the input.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 depicts an example embodiment of the disclosed technology.

FIG. 2 depicts an example embodiment of the disclosed technology.

FIG. 3 depicts an example embodiment of the disclosed technology.

FIG. 4 depicts the example impact of different combinations of flow restriction devices on RO waste reduction and permeate conductivity.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments of aspects can be combined with any part or parts of any one or more other embodiments or aspects.

The present invention describes a method and apparatus for a reduction in the wastewater generated in the laboratory ultrapure water purification system. As set forth herein, a part of the concentrate stream generated by a Reverse Osmosis (RO) module is recycled back in a recycle loop to mix with the incoming source tap water stream as a feed to the RO module. Such an arrangement reduces the concentrate stream volume in the waste line and simultaneously replaces a part of the tap water as an RO module feed, thereby reducing the overall water consumption of the water purification system. A recycle loop arrangement can include a solenoid valve and two flow restriction devices to selectively enable the recycling of the concentrate stream.

Based on a pre-determined or user-programmed limit in terms of conductivity for the incoming source water, the disclosed technology can, in one embodiment, operate a solenoid valve or other valve to enable or disable the recycling based on the ionic content of the incoming source tap water. Similarly, one can use the permeate conductivity or concentrate conductivity as a parameter to select between recycling and not recycling the RO concentrate.

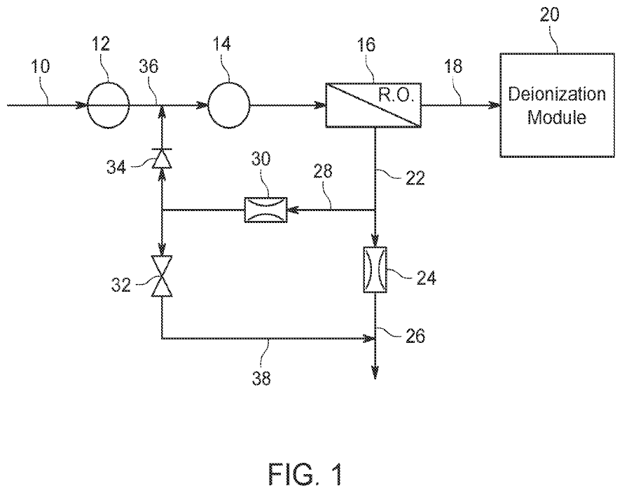

FIG. 1 depicts an exemplary, non-limiting configuration of the disclosed technology. The figure is an example depiction of a water purification model and does not include all the valves, pumps, and other components present in such a system. Additionally, a pre-treatment system can be utilized upstream of the feed to the said water purification module to remove particles and chemical compounds that may damage the operation of the RO module.

As shown, pre-treated tap water stream 10 enters in-line device 12—which device can be a sensor—to determine the inherent ionic load before entering into RO module 16 through booster pump 14. It should be understood, however, that in-line device 12 need not necessarily be present at the location shown in FIG. 1. For example, an in-line device can be present to assay a characteristic—such as ionic load, as one example—of the feed to RO module 16. Such a feed can be—as shown by element 36 in FIG. 1—a combination of water stream 10 and the stream (not labeled in FIG. 1) admitted through check valve 34.

The RO module in its standard operation generates a purified permeate water steam 18 that is further directed towards deionization module 20 through other system components such as ultraviolet treatment and ultrafiltration (not shown in FIG. 1).

The RO module operation also generates concentrate stream 22 containing rejected impurities; concentrate stream 22 can account for approximately 80% of the feed. This is not a requirement, however, as concentrate stream 22 can represent from about 1% up to about 99% of the feed. For example, concentrate stream 22 can represent from about 1% to about 99% of the feed, or from about 5% to about 95% of the feed, or from about 10% to about 90% of the feed, or from about 15% to about 85% of the feed, or from about 20% to about 80% of the feed, or from about 25% to about 75% of the feed, or from about 30% to about 70% of the feed, or from about 35% to about 65% of the feed, or from about 40% to about 60% of the feed, or from about 45% to about 55% of the feed, or even about 50% of the feed.

The concentrate 22 stream from the RO module 16 can be divided into multiple streams; as shown, stream 22 can be divided into two streams through an inline “T.” The concentrate 22 stream can be further divided if desired.

Part of stream 22 can be sent to the waste line 26 connected to a drain through a flow restriction device 24. The remainder enters into the recycle loop 28 and passes via another flow restriction device 30. It should be understood, however, that the location and number of flow restriction devices need not be as depicted in non-limiting FIG. 1.

For example, a flow restriction device can be present to restrict the flow of stream 26. A flow restriction device can also be present to restrict the flow of stream 18; a flow restriction device can also be present to restrict the flow of stream 22. As described elsewhere herein, a flow restriction device can be controllable. For example, the degree to which a flow restriction device restricts flow can be adjustable. In some embodiments, a flow restriction device is not adjustable and restricts flow in a set manner. More than two flow restriction devices can also be provided, and the more than two restriction devices can be connected to the same RO module or to different RO modules arranged in parallel.

As shown, the flow path of the concentrate stream in the said recycle loop 28 can depend on the state of solenoid 32. The OFF position or closed position of the said solenoid 32 allows the concentrate stream to stay in the recycle loop 28, where it passes through check valve 34 and mixes in with the source tap water in RO feed tube 36. Such an arrangement achieves a “water conservation” mode, allowing recycle of part of concentrate 22 to the feed of the RO module.

In the ON position or open position of solenoid 32, the said stream exits from the recycle loop 28 and merges with waste line 26 by traveling through line 38. Such an arrangement achieves a “standard” mode of operation.

In the laboratory water purification apparatus, deionization module 20 (DI) further purifies the permeate stream 18 exiting from RO module 16. The deionization module 20 can in some embodiments have beds that include ion exchange material to remove the ionic contaminants in permeate stream 18. The ion exchange capacity of the beds can be consumed rapidly if the permeate stream 18 consisted of relatively high levels of ions. The ionic purity in the RO feed tube depends upon the ionic load of the pre-treated tap water 10 and that of the concentrate stream recycled through recycle loop 28. A higher ionic load from feed 36 in turn implies a higher ionic load in the permeate stream 18, which more quickly utilizes the bed ion exchange capacity of the deionization module. Thus, the disclosed technology can reduce or even minimize the increase in the residual ionic load in the permeate stream 18 while achieving the maximum recycling of the concentrate stream 22. Such an equilibrium is achieved through designing the arrangements of the flow restriction devices 24 and 30. Such an arrangement selectively recycles the desired amount of water through the recycle loop 28 to mix with the pre-treated stream 10 in the RO feed tube 36. With the described arrangements, improved performance is achieved—for example, up to 50% savings in water consumption can be achieved with up to a 23% increase in the residual ionic load in the permeate stream 18.

By reference to FIG. 1, it should be noted that the solenoid valve 32 can be installed in an alternate embodiment on line 28. In such an embodiment, the lines connecting to solenoid valve 32 and 38 are no longer present (not shown). When the valve 32 is open in this embodiment, concentrate stream would flow via line 28, flow restrictor 30, and check valve 34, and mixes in with the source tap water in RO feed tube 36. When the solenoid valve 32 is closed in this embodiment, there is no flow via line 28 and the concentrate only flows via flow restrictor 24 to line 26 and waste.

A typical water purification device utilizes one flow restriction device on the concentrate line to aid in generating back pressure for the optimal operation of the RO module. The restriction rating of such a flow restriction device usually depends upon the capacity of the RO module. As an example, a 100-gallon/day RO membrane in a laboratory water purification system operates with a flow restriction device rated at 1000 mL/min installed on the concentrate side. The restriction devices act unlike back pressure coils in that the restriction is additive when they are in a parallel configuration. For example, two 500 mL/min restriction devices can be used in parallel on the concentrate line to achieve a summed restriction of 1000 mL/min. A flow control valve such as a solenoid valve can be used downstream from the second restrictor to control the direction of the flow. In an instant when the solenoid valve is open, the streams flowing through the restriction devices are split and combined before routing to waste. The pressure on the RO membrane remains nearly constant in such a configuration. Waste generation of the order of approximately 1000 mL/min was observed in the waste line. When the solenoid valve is closed, one stream is routed to waste as before, but the second stream from the second restriction device is routed for recycling. In this instance, the waste stream is in the order of approximately 500 mL/min. Thus, the present configuration provides a simple means of achieving the standard and recycle operation modes. Furthermore, in this embodiment the backpressure to the RO provides only small variation during the two states of the operation. Thus, consistent performance of the RO element is provided for.

As is seen, the disclosed configuration provides several advantages, among them:
The total restriction on the concentrate line is kept constant in either mode of operation so the back pressure to the RO is held nearly constant.
The constant backpressure ensures better performance of the RO membrane.
The restriction flow rates are identical to facilitate an intuitive waste generation profile with up to 50% saving in water consumption.
The waste generation and recycle amounts can be controlled by the split ratio of the two or more fixed output or variable output restriction devices.
There are no additional restriction devices as they can impact the overall RO pressure and the RO's performance deleteriously.

It should be noted that while a solenoid valve is used to stop the flow herein, other suitable flow-control valves can be used for the same purpose. In another embodiment, it is not essential to stop the flow recycled, as the flow can be reduced to control the volume recycled by utilizing variable output flow restriction devices. As per the disclosed technology, the stream from the additional restrictors that are in contact with the waste conduit if blocked allow for recycle operation with near-constant backpressure to the RO. The backpressure to the RO membrane is suitably in a specific range for the optimized operation, and the disclosed technology can remain within this range to maximize performance. Although some approaches include a flow restriction device in the concentrate line, a split configuration such as in the present invention that facilitates the recycling has not been implemented. By controlling the valve, the device enables operation in a standard or recycle mode of operation. Further as discussed, the valve function can be controlled based on the feed water quality by applying a software control.

As discussed above, the restriction ratings of the flow restriction devices on the waste line as well as the recirculation loop determine the portion of the concentrate stream routed to recycle loops versus directly to the waste tube. In “water conservation” mode, the flow restriction device with a larger restriction rating on the recycle loop allows larger amounts of water to pass through the loop to the feed of the RO module, while smaller amounts pass through the waste line. Such an arrangement, however, draws less water from the source tap water supply, increasing the overall ionic load at the feed of the RO module, in turn increasing the permeate ionic load, utilizing the bed ion exchange capacity of the deionization module more quickly. On the other hand, the flow restriction device with a larger restriction rating on the waste line allows larger amounts of water to pass directly to waste, increasing the total waste of the system. For the disclosed technology, different combinations of flow-restrictor devices were studied.

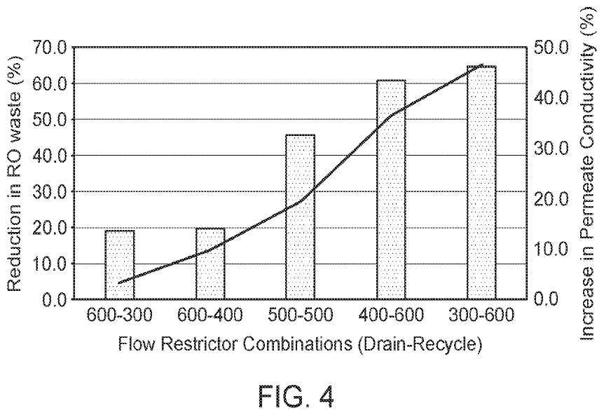

Table 1 (utilizing the element labels of FIG. 1) and FIG. 4 show an example reduction in the RO waste and an increase in permeate conductivity for a 100-gallon/day RO module. Because a typical water purification system would utilize one flow restriction device with a rating of 1000 mL/min on the concentrate line, that was considered as a control dataset. Moreover, the ratings of the flow restriction device on the concentrate and recycle loop were selected to sum up to or close to 1000 mL/min as control.

TABLE 1
Impact of different combinations of flow restriction devices on
RO waste reduction and increase in the permeate conductivity

| Flow | Flow | | | | | |
|---|---|---|---|---|---|---|
| restriction | restriction | Waste | Recycle | Permeate | RO waste | |
| device on | device on | line (26) | loop (28) | stream (18) | water | Permeate |
| waste line | recycle loop | flow rate | flow rate | conductivity | reduction | conductivity |
| (24) (mL/min) | (30) (mL/min) | (mL/min) | (mL/min) | (mS/cm) | (%) | increase (%) |
| 1000 | None | 933 | None | 16.9 | CONTROL | CONTROL |
| 600 | 300 | 756 | 276 | 17.5 | 19.0 | 3.6 |
| 600 | 400 | 750 | 320 | 18.6 | 19.6 | 10.1 |
| 500 | 500 | 508 | 500 | 20.2 | 45.6 | 19.5 |
| 400 | 600 | 367 | 603 | 23.1 | 60.7 | 36.7 |
| 300 | 600 | 330 | 599 | 24.8 | 64.6 | 46.7 |

Most laboratory water purification instruments have recommended operating limits for the ionic load of the incoming tap water. The incoming ionic load, most commonly indicated in conductivity or Total Dissolved Solids (TDS) further determines the ionic loads in the permeate as well as the concentrate stream. Therefore it has the greatest impact on the utilization of the ion exchange capacity of the deionization module. Specific to the water purification apparatus mentioned in the present invention, the higher conductivity of the pre-treated tap water stream 10 results in higher residual conductivity in the permeate stream 18 as the RO module typically rejects 98% of the incoming ions. Such high conductivity in stream 10 also results in a higher conductivity of rejected and concentrated ions in the recycle stream 28, in turn further increasing the conductivity in the RO feed tube when it mixes with the pre-treated water 10. Although the RO module quickly achieves equilibrium by rejecting the incoming higher ionic load from the recycle loop through RO feed tube 36, in such a case, it may not be ideal to recycle the concentrate. Instead, it should be sent to waste line 26 to achieve efficient operation. In the present invention, the operation of the solenoid 32 is linked to the ionic load measurement by the in-line device 12 through software logic. In such an inventive arrangement, when the ionic load passes the threshold above which the recycle operation is deemed to have an adverse effect on the DI module lifetime, the solenoid 32 receives a signal from the software logic to open, allowing the concentrate stream to exit from recycle loop 28 to merge into waste line 26. Municipal water quality can change seasonally, for example during the rainy season due to the presence of surface water the conductivity of the tap water is rather low. In such cases when the ionic concentration falls below the specified limit, the solenoid is closed through the software input thereby, allowing the concentrate stream to enter into the recycle loop. This innovative arrangement enables the balance between achieving sustainability and ensuring optimal system performance. It also ensures that the said water purification system is intelligent to operate in optimal conditions per the ionic concentration in tap water in different parts of the world.

### NON-LIMITING EXAMPLES

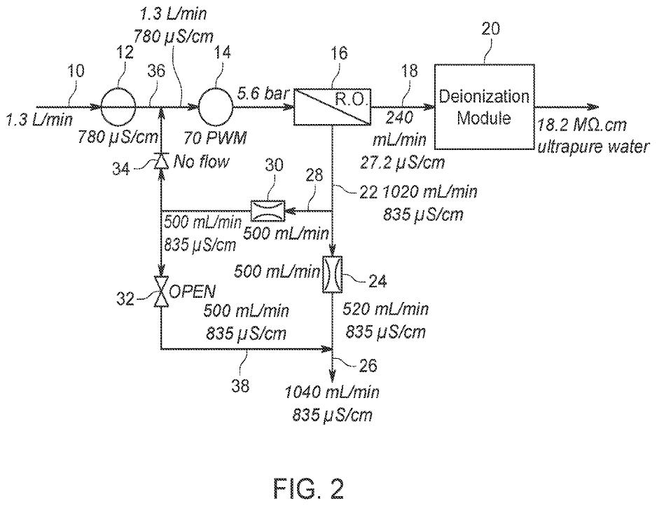

Example 1: Tap water regulated at 3.5 bar passes through the pre-filtration system containing a pre-filter, a softener, and a carbon cartridge. As described in non-limiting FIG. 2, the water then enters the water purification system through a feedwater solenoid at 1.3 liters/minute flow rate and flows through the conductivity cell of 0.16 cell constant equipped with a thermistor. A pre-set value of 760 μS/cm conductivity value was applied, above which the system is directed to exit from the water-conservation mode. The temperature-corrected conductivity value of 780 μS/cm is obtained by the software which signals the recirculation solenoid on the concentrate line to set OPEN. The water is boosted by a positive displacement pump to send to the RO module. The pulse width modulation for the pump is adjusted to 70% generating a pressure of 5.6 bar. The permeate stream with 27.2 μS/cm at 240 mL/min flowrate enters the DI module to generate 18.2 MΩ·cm ultrapure water that is stored in a reservoir. The concentrate stream, with 835 μS/cm at a 1020 mL/min flow rate passes through the two flow restriction devices (each rated to 500 mL/min restriction). The output of the flow restrictor on the waste line measures 520 mL/min whereas that in the recirculation loop allows 500 mL/min flow to pass through. The concentrate stream from the recirculation loop then exits the loop through the OPEN position of the recirculation solenoid to merge with the waste line. No flow was detected in the recycle loop merging into the RO feed line. The apparatus of the present invention allows selective operation of the system in the standard mode.

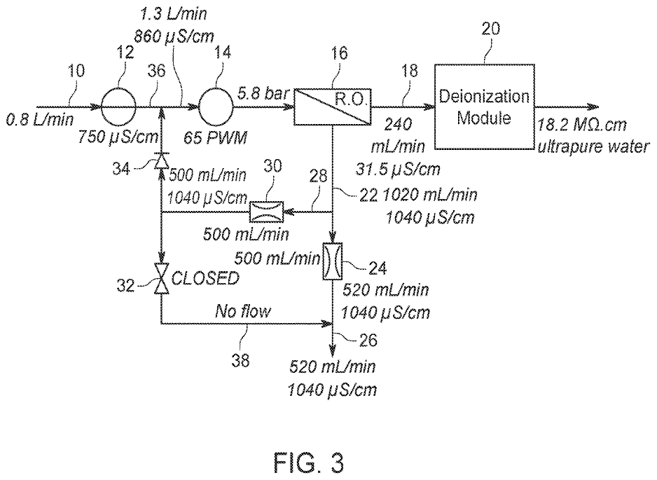

Example 2: As soon as the tap water ionic concentration drops below 750 μS/cm (below a pre-set value of 760 μS/cm threshold) the recirculation solenoid on the concentrate line is signaled immediately to set CLOSE (FIG. 3), placing the system in water conservation mode. The pulse width modulation for the pump can be adjusted to 65% to minimize the variation in the operating pressure of the RO module. The 500 mL/min flow out of the recycle loop restrictor is directed to merge with the incoming tap water. This reduces the feed water intake from 1.3 L/min to 0.8 L/min. The merging of both streams also increased the conductivity from 750 μS/cm to approximately 860 μS/cm. As the recycle loops come into equilibrium within a few seconds, the conductivity to the feed of the pump increased to 860 μS/cm. In the state of equilibrium, the permeate stream conductivity increases approximately 16% to 31.5 μS/cm. Simultaneously the concentrate stream reaches an equilibrium at 1040 μS/cm. The concentrate output through the flow restrictor on the waste line remains unchanged. The CLOSE position of the recycle solenoid generates no flow in tube 38 which was merged to the waste line, therefore generating total system waste of 520 mL/min, a net reduction of 50% in water usage compared with the standard mode described in Example 1.

### Aspects

The following Aspects are illustrative only and do not limit the scope of the present disclosure or the appended claims. Any part or parts of any one or more Aspects can be combined with any part or parts of any one or more other Aspects.

Aspect 1. A water purification system, comprising: a water feed path configured to receive an input water; a reverse osmosis module configured to (1) receive input from the water feed path and (2) output a permeate and a concentrate; and a recycle loop, the recycle loop being in fluid communication with the reverse osmosis module and the recycle loop being configured to receive the concentrate of the reverse osmosis module, the recycle loop being in fluid communication with an output and being configured to communicate a first portion of the concentrate to the output, and the recycle loop being convertible between (1) a recirculation state in which a second portion of the concentrate is communicated to the water feed path and (2) a standard state in which the second portion of the concentrate is communicated to the output.

Aspect 2. The water purification system of Aspect 1, further comprising a controller configured to effect conversion of the recycle loop between (1) one of the recirculation state and the standard state and (2) the other of the recirculation state and the standard state.

Aspect 3. The water purification system of any one of Aspects 1-2, further comprising a sensor configured to determine a characteristic of the input water.

Aspect 4. The water purification system of any one of Aspects 1-3, wherein the conversion is effected in response to at least one characteristic of the input water. The conversion can be effected, for example, when the characteristic of the input water exceeds a certain value, goes below a certain value, exceeds a certain value for a certain amount of time, goes below a certain value for a certain amount of time and the like.

The conversion can be effected at least in part based on a characteristic of the water that is input to the water feed path. The conversion can be effected at least in part based on a characteristic of the water that is input to the reverse osmosis module—the water that is input to the reverse osmosis module can be a combination of input water and concentrate that is output from the reverse osmosis module. The conversion can be effected at least in part based on a characteristic of permeate from the reverse osmosis module, for example permeate that is then communicated to a deionization module. The conversion can also be effected at least in part based on a characteristic of an output from a deionization module that receives permeates from the reverse osmosis module.

The conversion can thus be effected in a manual or an automated manner, and the conversion can be in response to the presence, level, or even lack of a characteristic in a steam of the water purification system. Ionic strength is one such characteristic, but other characteristics can be used individually or in combination.

The conversion can take place in an ongoing manner—for example, the conversion from one of the recirculation state and the standard state to the other of the recirculation state and the standard state can be effected when a characteristic of the input water exceeds a certain value, and conversion back to the first state can be effected when the characteristic of the input water falls below the certain value. Such a configuration is described in Example 1 and in Example 2 provided herein. In this way, the disclosed systems can operate in an automated manner and be responsive to changes that may take place in the input to the system.

Aspect 5. The water purification system of Aspect 4, wherein the at least one characteristic is an ionic strength.

Aspect 6. The water purification system of any one of Aspects 1-5, wherein the recycle loop comprises a junction that divides the concentrate into at least the first portion and the second portion. Such a junction can be, for example, a T-junction.

Aspect 7. The water purification system of Aspect 6, further comprising a flow control module configured to modulate flow of the second portion of the concentrate between the water feed path and the output. The flow control module can be, for example, a valve; solenoid valves are considered particularly suitable. The flow control module can also be, for example, a flow restriction device. A flow restriction device (e.g., element 24 and/or element 30 in FIG. 1) can be controllable such that the recirculation of concentrate from the reverse osmosis module is modulated by the flow restriction device. Although not shown in FIG. 1, a flow restriction device can be part of or downstream of waste line 26, which flow restriction device can modulate the amount of concentrate recirculation.

A flow control module can be in communication with a controller, sensor, or other module that provides the flow control module with a signal related to the presence, level, or even lack of a characteristic in a steam of the water purification system. Ionic strength is one such characteristic, but other characteristics can be used individually or in combination.

The flow control module can be configured to have only open and closed states. This is not a requirement, however, as the flow control module allow less than all fluid passage. By reference to FIG. 1, element 32 can be configurable such that 80% of the flow that is delivered to element 32 is communicated to stream 38 and 20% of the flow that is delivered to element 32 is communicated to element 34. Element 32 can be configured such that the relative diversion of fluid is variable—for example, element 32 can be configured such that a user can adjust the element to allow 90% of the flow that is delivered to element 32 to then be communicated to stream 38 and 20% of the flow that is delivered to element 32 is then communicated to element 34, but also such that a user can adjust the element to allow 50% of the flow that is delivered to element 32 to then be communicated to stream 38 and 50% of the flow that is delivered to element 32 is then communicated to element 34

Aspect 8. The water purification system of Aspect 7, wherein the flow control module comprises a solenoid.

Aspect 9. The water purification system of any one of Aspects 1-8, further comprising a flow restriction device configured to restrict flow of the first portion of the concentrate, the flow restriction device optionally having an adjustable flow restriction. Without being bound to any particular theory or embodiment, a flow restriction device can be used to modulate a backpressure. For example, flow restriction device 24 in FIG. 1 can modulate the backpressure experienced by reverse osmosis module 16.

Aspect 10. The water purification system of any one of Aspects 1-9, further comprising a flow restriction device configured to restrict flow of the second portion of the concentrate, the flow restriction device optionally having an adjustable flow restriction.

Aspect 11. The water purification system of any one of Aspects 1-10, further comprising a deionization module, the deionization module being configured to receive at least a portion of the permeate of the reverse osmosis module.

Aspect 12. The water purification system of any one of Aspects 1-11, wherein the recycle loop comprises a check valve configured to effect unidirectional flow of the second portion of the concentrate to the water feed path. By reference to FIG. 1, check valve 34 allows passage of the output of flow restriction device 30 to RO feed tube 36 without also permitting backflow.

Aspect 13. The water purification system of any one of Aspects 1-12, wherein the output comprises a waste line or a waste vessel.

Aspect 14. The water purification system of any one of Aspects 1-13, wherein the input water comprises a municipal water.

Aspect 15. The water purification system of any one of Aspects 1-13, wherein the input water comprises a pretreated water.

Aspect 16. A water purification system, comprising: a reverse osmosis module configured to (1) receive an input and (2) output a permeate and a concentrate; a deionization module configured to receive the permeate of the reverse osmosis module; and a recycle loop in fluid communication with the reverse osmosis module, the recycle loop being configured to vary an amount of the concentrate of the reverse osmosis module that is communicated to the input.

Aspect 17. The water purification system of Aspect 16, wherein the recycle loop is convertible between (1) a first state in which the input is free of concentrate of the reverse osmosis module and (2) a second state in which the input includes at least some of the concentrate of the reverse osmosis module. The conversion can be effected in a manual or an automated manner, and the conversion can be in response to the presence, level, or even lack of a characteristic in a steam of the water purification system. Ionic strength is one such characteristic, but other characteristics—for example, conductivity—can be used individually or in combination.

Aspect 18. A method, comprising operating a water purification module of any one of Aspects 1-17.

Aspect 19. A method, comprising: with (a) a reverse osmosis module configured to (1) receive an input and (2) output a permeate and a concentrate and (b) a deionization module configured to receive the permeate of the reverse osmosis module, varying an amount of the concentrate of the reverse osmosis module that is communicated to the input.

Aspect 20. The method of Aspect 19, wherein the varying is modulated based at least in part on at least one characteristic of the input. The varying can be effected in a manual or automated manner, and can be in response to the presence, level, or even lack of a characteristic in a steam of the water purification system. Ionic strength is one such characteristic, but other characteristics can be used individually or in combination.

It may be noted that while the elements of water purification are described to those skilled in the art, the placement of the element may be altered. One can also add other elements, such as EDI (Electrodeionization) modules and the like.

1. A water purification system, comprising:
a water feed path configured to receive an input water;
a reverse osmosis module configured to (1) receive input from the water feed path and (2) output a permeate and a concentrate; and
a recycle loop,
the recycle loop being in fluid communication with the reverse osmosis module and the recycle loop being configured to receive the concentrate of the reverse osmosis module,
the recycle loop being in fluid communication with an output and being configured to communicate a first portion of the concentrate to the output, and
the recycle loop being convertible between (1) a recirculation state in which a second portion of the concentrate is communicated to the water feed path and (2) a standard state in which the second portion of the concentrate is communicated to the output.

2. The water purification system of claim 1, further comprising a controller configured to effect conversion of the recycle loop between (1) one of the recirculation state and the standard state and (2) the other of the recirculation state and the standard state.

3. The water purification system of claim 1, further comprising a sensor configured to determine a characteristic of the input water.

4. The water purification system of claim 2, wherein the conversion is effected in response to at least one characteristic of the input water.

5. The water purification system of claim 4, wherein the at least one characteristic is an ionic strength.

6. The water purification system of claim 1, wherein the recycle loop comprises a junction that divides the concentrate into at least the first portion and the second portion.

7. The water purification system of claim 6, further comprising a flow control module configured to modulate flow of the second portion of the concentrate between the water feed path and the output.

8. The water purification system of claim 7, wherein the flow control module comprises a solenoid.

9. The water purification system of claim 1, further comprising a flow restriction device configured to restrict flow of the first portion of the concentrate, the flow restriction device optionally having an adjustable flow restriction.

10. The water purification system of claim 1, further comprising a flow restriction device configured to restrict flow of the second portion of the concentrate, the flow restriction device optionally having an adjustable flow restriction.

11. The water purification system of claim 1, further comprising a deionization module, the deionization module being configured to receive at least a portion of the permeate of the reverse osmosis module.

12. The water purification system of claim 1, wherein the recycle loop comprises a check valve configured to effect unidirectional flow of the second portion of the concentrate to the water feed path.

13. The water purification system of claim 1, wherein the output comprises a waste line or a waste vessel.

14. The water purification system of claim 1, wherein the input water comprises a municipal water.

15. The water purification system of claim 1, wherein the input water comprises a pretreated water.

16. A water purification system, comprising:
a reverse osmosis module configured to (1) receive an input and (2) output a permeate and a concentrate;
a deionization module configured to receive the permeate of the reverse osmosis module; and
a recycle loop in fluid communication with the reverse osmosis module, the recycle loop being configured to vary an amount of the concentrate of the reverse osmosis module that is communicated to the input.

17. The water purification system of claim 16, wherein the recycle loop is convertible between (1) a first state in which the input is free of concentrate of the reverse osmosis module and (2) a second state in which the input includes at least some of the concentrate of the reverse osmosis module.

18. A method, comprising operating a water purification module of claim 1.

19. A method, comprising:
with (a) a reverse osmosis module configured to (1) receive an input and (2) output a permeate and a concentrate and (b) a deionization module configured to receive the permeate of the reverse osmosis module,
varying an amount of the concentrate of the reverse osmosis module that is communicated to the input.

20. The method of claim 19, wherein the varying is modulated based at least in part on at least one characteristic of the input.
